(19) United States
(12) Patent Application Publication
(10) Pub. No.: US 2009/0120403 A1
(43) Pub. Date: May 14, 2009

(54) ENGINE ASSEMBLY FOR A VEHICLE

(75) Inventor: Stephanie MALCUY, Sartrouville (FR)

Correspondence Address: OBLON, SPIVAK, MCCLELLAND MAIER & NEUSTADT, P.C., 1940 DUKE STREET, ALEXANDRIA, VA, 22314, US

(73) Assignee: RENAULT S.A.S, BOULOGNE BILLANCOURT (FR)

(21) Appl. No.: 11/911,036

(22) PCT Filed: Apr. 7, 2006
(86) PCT No.: PCT/FR06/50315

§ 371 Date: Oct. 9, 2007

(30) Foreign Application Priority Data
Apr. 11, 2005 (FR) 0503548

(51) Int. Cl. F02B 77/00

(52) U.S. Cl. 123/195 R

(57) ABSTRACT

An engine assembly for a vehicle, including a tie-rod connected to the engine, a suspension for fixing to the vehicle chassis, and a connector fixed to the engine, on which the tie-rod and the suspension are mounted. The connector is configured to physically decouple the tie-rod from the suspension.

The invention relates to the field of suspensions for engines for vehicles such as motor vehicles and, in particular, the attachment of the engine to the body.

According to known designs in which the engine is suspended in a pendular manner from the body, there are two points of attachment of the engine to the body: the right front suspension and the left front suspension. For engines that develop a high torque, it is often necessary to have the torque reacted by two link rods, a lower link rod generally situated close to the center of gravity of the power plant, and an upper link rod, close to the right front suspension.

At the present time, the upper link rod is fixed to the right front suspension of the engine, this type of attachment making it possible to avoid redesigning engine parts and entailing merely modifications to the right suspension in order to accept the upper link rod.

One disadvantage with this design is that the assembly made up of the right front suspension, of the engine and of the upper link rod is a unitary assembly of significant mass. This assembly generates its own natural deformation modes in a frequency band that is detrimental to the acoustics within the cabin.

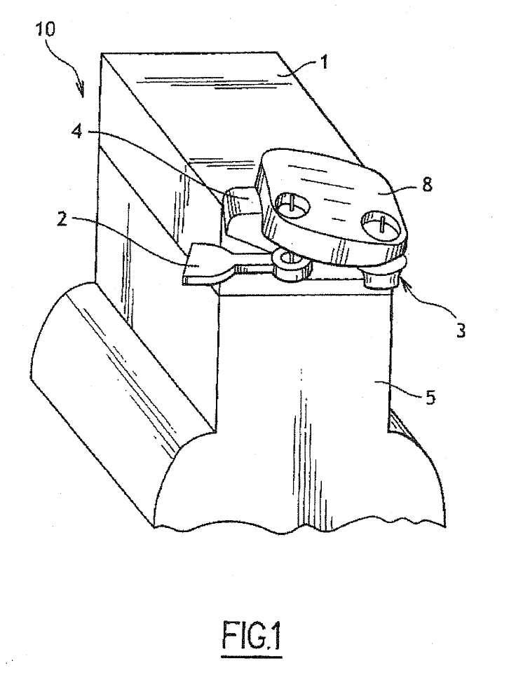

FIG. 1 depicts an example of an engine assembly 10 currently used, comprising an engine cylinder head 1 and a cylinder block 5. An engine suspension means 3, together with a torsion rod 2, are supported by the same part 8, itself fixed to the engine support 4, at the engine end.

The assembly 10 leads to a significant mass, offset considerably from the axis of the engine, thus causing high levels of vibration which will be injected directly into the body and transmitted to the cabin, generating medium frequency (typically 300 to 600 Hz) noise.

To improve the situation, the present invention in a first of its aspects proposes a vehicle engine assembly comprising a link rod connected to the mechanism of the engine, a suspension means intended to be fixed to the body of the vehicle, and an intermediate means secured to the engine on which the link rod and the suspension means are mounted, characterized in that the intermediate means is designed to physically dissociate the link rod from the suspension means.

Thus, it will in particular be possible to minimize the transmission of load between the link rod and the suspension means.

Other features of the invention may be:
the intermediate means has a concave surface on which the link rod is mounted;
the intermediate means comprises an extension to accept the pivot pin of the link rod;
the intermediate means has grooves designed to react load transmitted by the link rod;
the intermediate means is a part fixed to the engine block;
the intermediate means is an aluminum part fixed to the engine block;
the part is made of a material that is stiff enough to damp the load coming from the link rod;
the link rod is a torsion rod;
the link rod is a link rod mounted high up on the engine;
the pivot pin used to fix the link rod to the intermediate means is substantially parallel to the axis of the engine;
the suspension means comprises an arm and a damping means to be fixed to the body, the arm extending from the damping means to the intermediate means to which it is fixed.

In a second of its aspects, the invention proposes a vehicle comprising such an engine assembly.

Other features, objects and advantages of the invention will become apparent from the description which follows, which is purely illustrative and nonlimiting, and which is to be read in conjunction with the attached drawings in which:

FIG. 1 depicts a three-dimensional view of a known engine assembly;

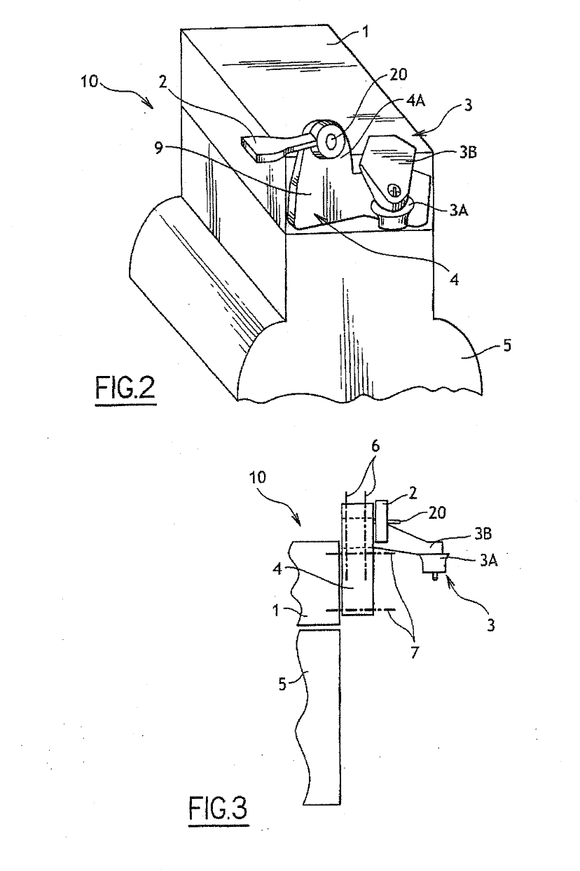

FIG. 2 depicts a three-dimensional view of an engine assembly according to the invention; and

FIG. 3 depicts a side view of the engine assembly according to FIG. 2.

Each component of an engine assembly, for example of the power plant type, has its own natural deformation modes, particularly the elements that suspend the engine from the body. When the engine is running, these natural modes will be influenced by the engine harmonics and responsible for vibration. At the engine suspension, the vibration will be transmitted directly to the body, and will be responsible for noise in the cabin. To improve the vehicle acoustics, it is necessary to seek to reduce this vibration.

One solution proposed here is to physically and modally dissociate the engine suspension from the torsion rod, each system then being able to vibrate separately, without the natural modes interacting.

To this end and with reference to FIGS. 2 and 3, the engine assembly according to the invention comprises:
a link rod 2, possibly a torsion rod, able to be mounted on the engine 5;
a suspension means 3 able to be fixed to the body of the vehicle;
an intermediate means or part 4 secured to the engine 5 and on which the link rod 2 and the suspension means 3 are mounted.

In the remainder of this document, the link rod 2 is considered to be an upper link rod, that is to say one positioned high up on the engine 5 when the engine is in place in the vehicle. Here, the link rod 2 is thus mounted on the cylinder head 1 of the engine, above the cylinder block 5. However, those skilled in the art will understand that this engine assembly can also be adapted in ways that are obvious and direct in order to comprise a link rod 2 mounted in a lower or intermediate position.

The pivot pin 20 of the link rod 2 is advantageously substantially parallel to the axis of the engine, as this is beneficial for reacting load. The overhanging mass is thus reduced, and the vibration transmitted is thus reduced. The link rod 2 is mounted on the cylinder head 5 via the intermediate means 4.

The intermediate means 4 is integrally formed in the engine (here, the cylinder head 5) or as an intermediate part 4 fixed to the engine.

FIGS. 2 and 3 depict the case of an intermediate part 4 fixed to the engine by fixing means 7 such as screws or other means known to those skilled in the art.

The intermediate part 4 is designed to accommodate the link rod 2. The intermediate part 4 thus possibly comprises an extension 4A as far as the region to which the pivot pin 20 to which the link rod 2 is fixed is to be attached. The design of the intermediate means or part 4 may also comprise a concave surface 9 on which the link rod 2 is mounted. This concave surface 9, which defines a cavity in which at least part of the link rod 2 is housed, thus making it possible to reduce the space occupied by the engine.

The intermediate part 4 is also advantageously chosen to be stiff enough so that it can absorb load coming from the link rod 2. Provision may be made to add grooves (not illustrated in the figures) so as to increase the rigidity so that the load transmitted by the link rod 2, particularly as the engine torque increases, can be reacted.

It may be possible to choose to make the intermediate part 4 from aluminum.

The link rod 2 can then be mounted initially by screwing the pivot pin 20, which is threaded accordingly, into the thickness of the intermediate part 4.

The engine assembly suspension means 3 according to the invention is intended to be fixed to the body of the vehicle. It comprises a damping means 3A to be fixed to the body, and an arm 3B running from this damping means 3A to the intermediate part 4 on which it is mounted. The arm 3B may be mounted on the intermediate part 4 using screws 6 for example.

The suspension means 3 and the link rod 2 are thus physically separate, and their natural modes of deformation dissociated.

Furthermore, because of the dissociation, the natural modes are higher in terms of frequency and therefore fall within frequency bands that are better filtered by the filtering elements, such as engine mounts.

The engine assembly, which may for example be a power plant, is then suspended from the body in a pendular manner.

The link rod 2 is then fixed to its pivot pin 20.

By comparison with a conventional design, the invention in particular allows the link rod 2 to be dissociated from the engine suspension means 3 and therefore affords the following advantages in particular:
the physical dissociation of the link rod 2 with respect to the suspension means 3 is such that the upper link rod and the suspension have separate modes, without any interaction, and at higher frequencies than a system in which the link rod 2 is mechanically connected to the suspension 3, because the masses involved during the modal movement are lower. Thus, the modes are transferred beyond the engine excitation harmonics. Vibrational deformations are therefore less extensive,
since the link rod 2 and the suspension means 3 are physically separate, these two latter points of input of load to the body can therefore be filtered separately, for example by their own engine mounts,
the link rod 2 is fixed directly to the engine, via the pivot pin 20 and the intermediate means 4, thus limiting the effects of dynamic amplification on its natural modes,
since the pivot pin 20 of the link rod 2 is substantially parallel to the axis of the engine 5, the overhang between the engine axis and the link rod 2 is reduced, and the vibrational amplitudes at this link rod are therefore further reduced,
by reducing the unsupported mass, vibration in the engine suspension is also reduced.

1-12. (canceled)

13. A vehicle engine assembly comprising:
a link rod connected to the engine;
a suspension configured to be fixed to a body of the vehicle; and
a connector secured to the engine on which the link rod and the suspension are mounted,
wherein the connector is configured to physically dissociate the link rod from the suspension.

14. The engine assembly as claimed in claim 13, wherein the connector has a concave surface on which the link rod is mounted.

15. The engine assembly as claimed in claim 13, wherein the connector includes an extension to accept a pivot pin of the link rod.

16. The engine assembly as claimed in claim 13, wherein the connector includes grooves configured to react load transmitted by the link rod.

17. The engine assembly as claimed in claim 13, wherein the connector is a part fixed to a block of the engine.

18. The engine assembly as claimed in claim 13, wherein the connector includes an aluminum part fixed to a block of the engine.

19. The engine assembly as claimed in claim 17, wherein the part is made of a material that is stiff enough to damp the load coming from the link rod.

20. The engine assembly as claimed in claim 13, wherein the link rod is a torsion rod.

21. The engine assembly as claimed in claim 13, wherein the link rod is a link rod mounted high up on the engine.

22. The engine assembly as claimed in claim 15, wherein the pivot pin used to fix the link rod to the connector is substantially parallel to the axis of the engine.

23. The engine assembly as claimed in claim 13, wherein the suspension comprises an arm and a dampener to be fixed to the body, the arm extending from the dampener to the connector to which it is fixed.

24. A vehicle comprising:
an engine assembly as claimed in claim 13.
